(19) United States
(12) Patent Application Publication
(10) Pub. No.: US 2015/0159801 A1
(43) Pub. Date: Jun. 11, 2015

(54) Electrically Driven Support Base

(71) Applicant: Tadashi Oda, Osaka (JP)

(72) Inventor: Tadashi Oda, Osaka (JP)

(21) Appl. No.: 14/406,845

(22) PCT Filed: Jun. 6, 2013
(86) PCT No.: PCT/JP2013/003568

§ 371 Date: Dec. 10, 2014

(30) Foreign Application Priority Data
Jun. 29, 2012 (JP) 2012-147845

(51) Int. Cl. F16M 11/04; F16M 11/12; G03B 17/56; F16M 11/18

(52) U.S. Cl. CPC F16M 11/046; F16M 11/18; F16M 11/126; G03B 17/561

(57) ABSTRACT

Provided is an electrically driven support base which is configured so as to prevent the rotation-induced shaking of a pole for supporting a camera mounting head and so as to enable the automatic adjustment of the position in height of a camera. One end of a flexible transmission belt (drive cord (12)) is connected to a multi-stage telescoping pole (2) having a mounting head (50) provided to the front end pole (46) of the multi-stage telescoping pole (2), and the drive cord (12) is engaged with a gear connected to an electric motor (23). The multi-stage telescoping pole (2) is extended or retracted by paying out or pulling in the drive cord (12). A camera means can be mounted on the mounting head (50), and the multi-stage telescoping pole (2) is provided with a rotation-induced shaking prevention means for each stage pole.

### TECHNICAL FIELD

The present invention relates to an electrically-driven support base which is equipped with a telescoping pole so as to enable electrical elevation of a tripod on which a digital camera, a camera-equipped mobile phone, a digital video camera or the like is mounted, in place of operating elevation of the tripod (elevator) by hand.

### BACKGROUND ART

Where a camera is used to take pictures, in general, a tripod which manually adjusts a position of the camera has been widely used, with an electrically-driven tripod not yet widely used.

An electrically-driven tripod is such that a unit which allows an elevator rod to move up and down electrically is arranged on a support base of a home-use video camera (for example, refer to Patent literature 1).

Although not a tripod, there are available devices which may be cited as references of the present invention. The devices include, for example, a corner pole device for vehicle which is equipped with a telescoping pole and a driving mechanism having a toothed drive code (for example, refer to Patent literature 2).

There is also available a telescoping-pole driving device for vehicle which has a device for motor-driving a wind-up drum for winding a drive code (for example, refer to Patent literature 3).

### PRIOR ART

[Patent literature 1] JP1997-292093A (Page 7, FIG. 3)
[Patent literature 2] JP3551429B (Page 16, FIG. 1)
[Patent literature 3] JU1991-3078A (Page 5, FIG. 2)

### OUTLINE OF THE INVENTION

### Problems to be Solved by the Invention

When taking a picture with a video camera by using a tripod, an elevator handle is manually operated, while visually confirming a photographic object to adjust a height position. Further, when changing the height position in the course of photographing, the handle is also manually operated. That is, an existing tripod has a disadvantage that a video camera is required to be manually adjusted for the height position.

The support base for home-use video camera disclosed in said Patent Document 1 is a special support base, or a tetrapod having four legs under which rollers are installed so as to move freely. Further, the support base is designed to have a heavy electrically-driven device at a site high in gravity point. Thus, this is not a portable tripod light in weight. Still further, an elevating distance of the elevator rod depends on the length of the folded legs. Where the length thereof exceeds the elevating distance, it is necessary to adjust the tetrapod, which is inconvenient.

In addition, a corner pole device for the vehicle disclosed in said Patent Document 2 is such that a telescoping pole and a toothed-drive-code driving mechanism are arranged. In this case, the telescoping pole has a cylindrical cross section and is configured so as to be telescoped, which results in a defect of rotational shake on elevation.

In the above-described situation, of functions of a tripod, motor operation of elevator function has not yet become practical to use and motor operation is crucial for realizing automatic adjustment of a height position.

In view of the above-described situation, an object of the present invention is to provide an electrically-driven support base which prevents a pole for supporting a mounting head of a camera from rotational shake and performs automatic adjustment of a height position of the camera.

### Means to Solve the Objects

In order to attain said object, the electrically-driven support base of the present invention is a device in which one end of a flexible transmission belt is coupled to a multi-stage telescoping pole having a mounting head at a leading-end pole, the transmission belt is engaged with a gear coupled to an electric motor, by which the transmission belt is pushed out or pulled in, thereby allowing the multi-stage telescoping pole to undergo telescopic motion. And, the electrically-driven support base is constituted in such a manner that the mounting head is able to install a camera unit and the multi-stage telescoping pole is provided with a rotational-shake prevention unit on a pole at each stage.

According to the above-described constitution, the transmission belt is pushed out or pulled in, thereby allowing the multi-stage telescoping pole to undergo telescopic motion, changing an elevating distance of the mounting head on which the camera unit is installed, thus making it possible to change a height position. Further, when the multi-stage telescoping pole is allowed to undergo telescopic motion to change the elevating distance of the mounting head, thereby changing the height position, there is a fear that the load of the camera unit may cause rotational shake of the pole. Rotational shake of the pole will result in rotational shake of the mounting head mounted on the leading-end pole. As a result, the camera unit mounted on the mounting head will undergo a posture deviation. Thus, in the present invention, the rotational-shake prevention unit is provided on a pole at each stage, thereby avoiding occurrence of rotational shake on elevation of the pole at each stage.

Here, the camera unit covers mainly a camera, a video camera and a mobile-phone annexed camera and also covers a microphone, a speaker and other electronic instruments mounted on a camera, in addition to the above-described cameras.

Further, the mounting head includes such that the bottom of a camera unit is placed on the mounting head to fix firmly the camera unit on the mounting head with screws or the like, such that the mounting head itself assumes a shape in agreement with the shape of the camera unit so that the camera unit can be fitted therein, and such that a part of the camera unit is held or fastened etc.

Still further, the multi-stage telescoping pole is able to dramatically increase by several folds the movement distance of the leading end of a pole, that is, the movement distance of the mounting head by increasing the number of stages of the telescoping pole.

When being pushed out, the transmission belt is to extend linearly the multi-stage telescoping pole, while supporting loads of the camera unit and the mounting head. Therefore, it is preferable that a guide is provided so that the transmission belt is pushed out linearly inside the multi-stage telescoping pole.

Here, the rotational-shake prevention unit of the electrically-driven support base in the present invention is, more specifically, such that a linear groove is provided axially on a wall of a pole at each stage so that the multi-stage telescoping pole undergoes linear telescopic motion.

Further, said pole at each stage has a cross section, the shape of which is a combination of tubular polygon, tubular oval and tubular semi-circle as well as circle, polygon, oval and semi-circle. The pole at each stage is telescoped so that the multi-stage telescoping pole undergoes linear telescopic motion.

It is also preferable that an intermediate guide of the transmission belt is provided at an intermediate pole of the multi-stage telescoping pole.

Further, it is preferable that the mounting head is additionally provided with a driving unit which pans or tilts a camera unit or a camera lens internally housed in the camera unit and able to operate the driving unit by wire or wireless communications. It is more preferable that the mounting head is provided with a driving unit which is able to perform both pan and tilt operations in view of handling of the camera unit.

It is also preferable that a tripod is installed on a main body of the electrically-driven support base. The main body of the electrically-driven support base is, more specifically, such that a driving mechanism by an electric motor is installed on a board.

Further, it is preferable that a signal sending/receiving device capable of remote-controlling the elevation of the multi-stage telescoping pole by wireless or infrared communications is assembled into the main body. A pole at each stage of the electrically-driven support base can be controlled for elevation from a place away from the base, thereby improving convenience. The signal sending/receiving device is able to make wireless or infrared communications, that is, the device sends information on pan and tilt or positional information on an elevator as well as receives elevation/operation data of the multi-stage telescoping pole.

In addition, the multi-stage telescoping pole may be controlled for elevation thereof by the signal sending/receiving device assembled into the main body by way of wire communications such as a signal cable.

Where a camera is mounted on the mounting head to take pictures, it is preferable to install a controller which remote-controls a main body of the camera and elevation of the multi-stage telescoping pole in an integrated manner. Thus, the main body of the electrically-driven support base and the main body of the camera can be operated more conveniently.

### Effects of the Invention

According to the present invention, there are provided such effects that the pole which supports the mounting head of a camera can be prevented from rotational shake to automatically adjust a height position of the camera.

Further, the present invention enables motor operation of an elevator function, among functions of a tripod, and is not only able to realize an electrically-driven support base which is portable but also able to extend an elevating/moving distance of the elevator two times or more the length of the pole by increasing the number of stages of the telescoping pole.

Still further, there is provided the controller which remote-controls the main body of the camera and elevation of the multi-stage telescoping pole in an integrated manner, thus making it possible to remote-control the camera simultaneously on photographing and elevation of a position of the camera.

### BRIEF DESCRIPTION OF THE DRAWINGS

FIG. 1 shows a front view of the electrically-driven support base of Embodiment 1.

FIG. 2 shows a right-side lateral view of the electrically-driven support base of Embodiment 1.

FIG. 3 shows an exploded perspective view of the electrically-driven support base of Embodiment 1.

FIG. 4 shows an explanatory view of the driver of the electrically-driven support base of Embodiment 1.

FIG. 5 shows an explanatory view of the controller of the electrically-driven support base of Embodiment 1.

FIG. 6 shows a cross sectional view taken along the line of A to A′ of the electrically-driven support base of Embodiment 1.

FIG. 7 shows a cross sectional view of the telescoping pole taken along the line of B to B′ of the electrically-driven support base of Embodiment 1.

FIG. 8 shows a front view of the electrically-driven support base of Embodiment 2.

FIG. 9 shows a cross sectional view of the main body driver taken along the line of C to C′ of the electrically-driven support base of Embodiment 2.

FIG. 10 shows a perspective of the telescoping pole without a base end groove of the electrically-driven support base of Embodiment 3.

FIG. 11 shows a perspective view of the rectangular telescoping pole of the electrically-driven support base of Embodiment 4.

FIG. 12 shows a cross sectional view of the telescoping pole taken along the line of B to B′ (in which an intermediate guide is assembled to the telescoping pole) of the electrically-driven support base of Embodiment 5.

FIG. 13 shows an exploded perspective view of the electrically-driven support base which explains Embodiment 6 to Embodiment 8. Embodiment 6 is such that an electrically-driven pan/tilt device is assembled into the telescoping pole. Embodiment 7 is such that a tripod is assembled to the main body of the electrically-driven support base. Embodiment 8 is such that a signal receiving controller by wireless or infrared communications is assembled to the main body of the electrically-driven support base.

FIG. 14 shows an explanatory view of the electrically-driven support base of Embodiment 9.

### BEST MODE FOR CARRYING OUT THE INVENTION

Embodiments of the present invention will be described in detail below with reference to the drawings. The present invention is not limited to the following embodiment and examples of shown in the figure, and the present invention can be variously changed in design.

### Embodiment 1

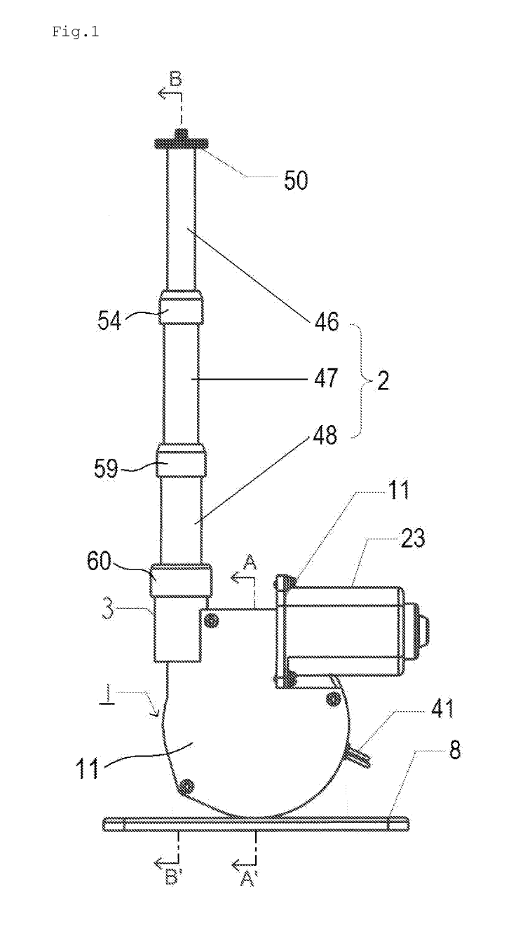

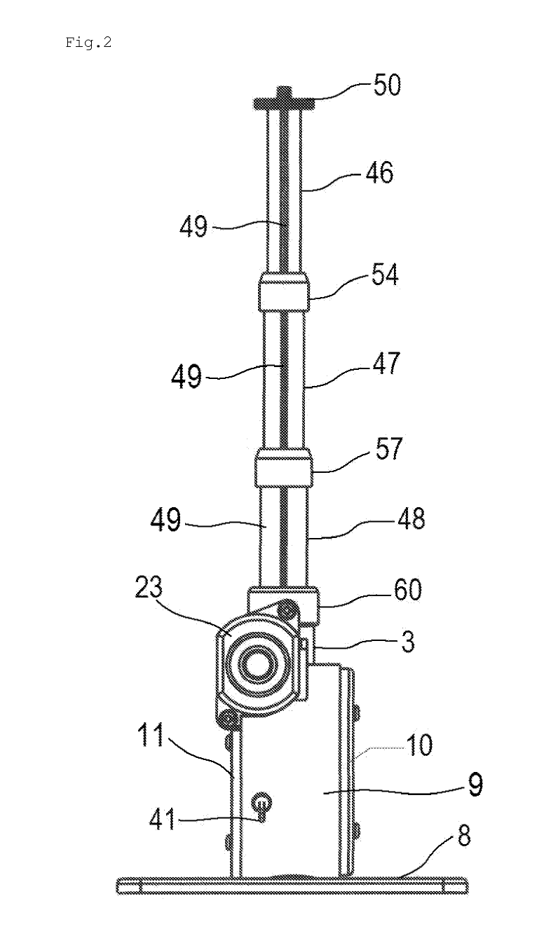

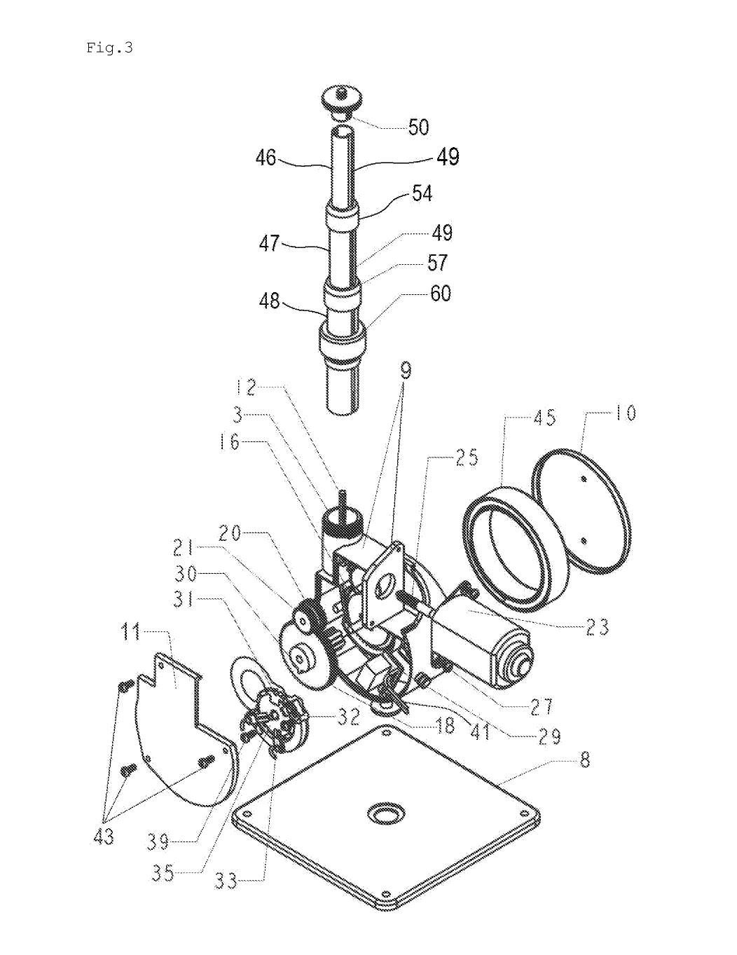

In FIG. 1 through FIG. 7, they show an electrically-driven support base of Embodiment 1. As shown in FIG. 1, a three-stage telescoping pole 2 is assembled into a main body 1 of an electrically-driven support base. The main body 1 is constituted with a pole assembly portion 3, a driver, a controller, an accommodating portion and a motor assembling portion. The main body 1 is supported by a board 8. As shown in FIG. 2 and FIG. 3, an outer hull of the main body 1 is constituted with a main body case 9, a front cover 10 and a rear cover 11. The main body case 9 and the front cover 10 are formed with a high-strength synthetic resin, while the rear cover 11 is formed with a metal.

The driver and the controller are provided at the center of the interior of the main body case 9. The pole assembly portion 3 is provided at an upper end of the interior of the main body case 9 and the motor assembling portion is provided at the other upper end thereof. Next, an accommodating portion of the drive code 12, which is the transmission belt, is provided at the rear of the driver, and a space between them is partitioned with a case barrier 13. A cord accommodating channel 14 is provided by boring a hole on the case barrier 13 below the main body case 9 so as to smoothly accommodate the drive code 12, and a tunnel-like cover is provided thereon.

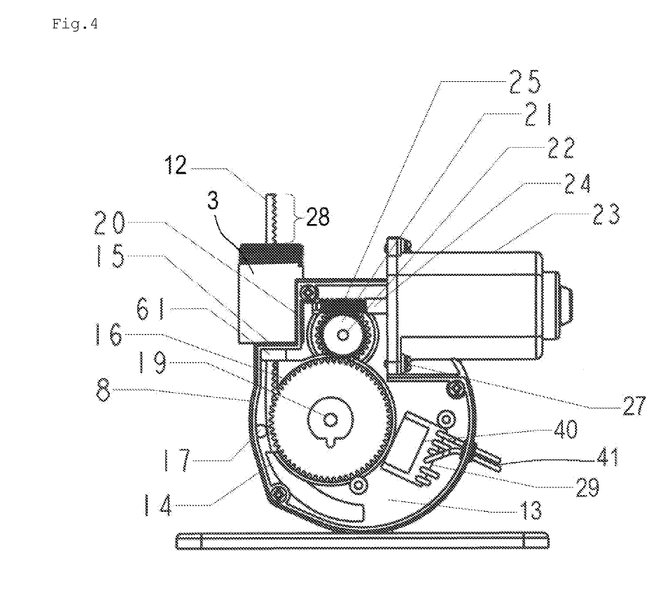

As shown in FIG. 4, the driver is provided with the drive code 12 which leads to the accommodating portion by way of a gear C16 from a pole lower-channel 15, and the gear C16 is meshed with the drive code 12, thereby pushing out and pulling in the drive code 12. Next, a guide 17 is provided at a back side thereof which meshes with the drive code 12 so that the drive code 12 will not wrongly mesh with the gear C16. Further, the gear C16 rotates with a gear B18 in a synchronized manner, and these two gears rotate at the center of a supporting shaft B19 installed on the case barrier 13. Next, a gear A20 which meshes with the gear B18 is installed above the gear B18. The gear A20 is integrally formed with a worm wheel 21 and rotates at the center of a supporting shaft A22 installed on the case barrier 13. The worm wheel 21 meshes with a worm gear 25 which is fixed to an output shaft 24 of an electric motor 23. The electric motor 23 is assembled to a motor assembling portion of the main body case 9 and screwed with a screw 27. The drive code 12 is made of a flexible synthetic resin having an appropriate strength, and a tooth portion 28 is formed in the longitudinal direction thereof.

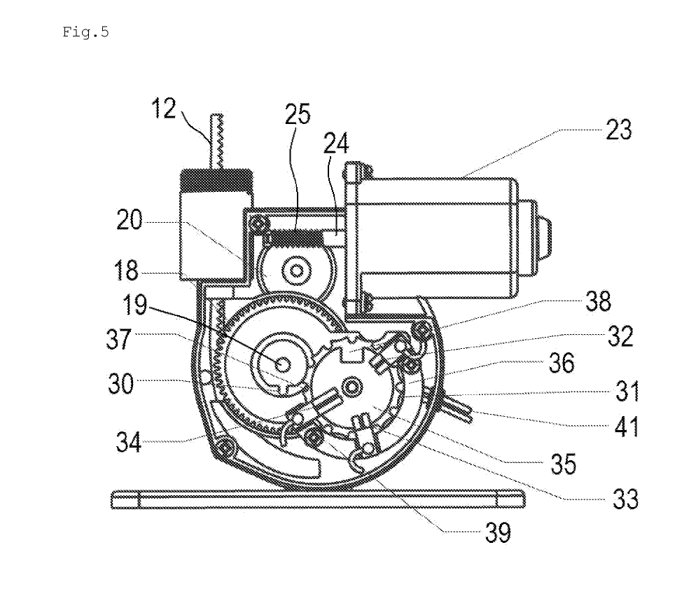

The controller is constituted with a printed wiring board 29 and a unit for detecting the length of the telescoping pole 2 (refer to FIG. 4). Here, the unit for detecting the length is, as shown in FIG. 5, constituted with a driving cam 30, a driven cam 31, fixed contact boards A32, B33, C34, and a movable contact board 35. The driving cam 30 is integrally formed on one face of the gear B18, and the driven cam 31 meshing with the driving cam 30 is supported on a cam frame 36 so as to move rotationally. Cam recessed portions 37 are formed at equal intervals on the driven cam 31. The movable contact board 35 is fixed on one face of the driven cam 31. The movable contact board 35 is provided with a substantially circular partial notch 38, and the notch 38 switches electricity so as to be conductive or non-conductive. Three fixed contact boards 32, 33, 34 are mounted on the cam frame 36. Each of the fixed contact boards 32, 33, 34 is made of an elastic conductive metal and mounted on the cam frame 36 with a screw S39 so as to be in contact with the movable contact board 35.

As shown in FIG. 4, the printed wiring board 29 is installed at the rear of the cam frame 36 to which a relay 40 is assembled. A lead wire 41 is connected to a switch (not illustrated) from the printed wiring board 29 by way of an opening portion installed on the main body case 9.

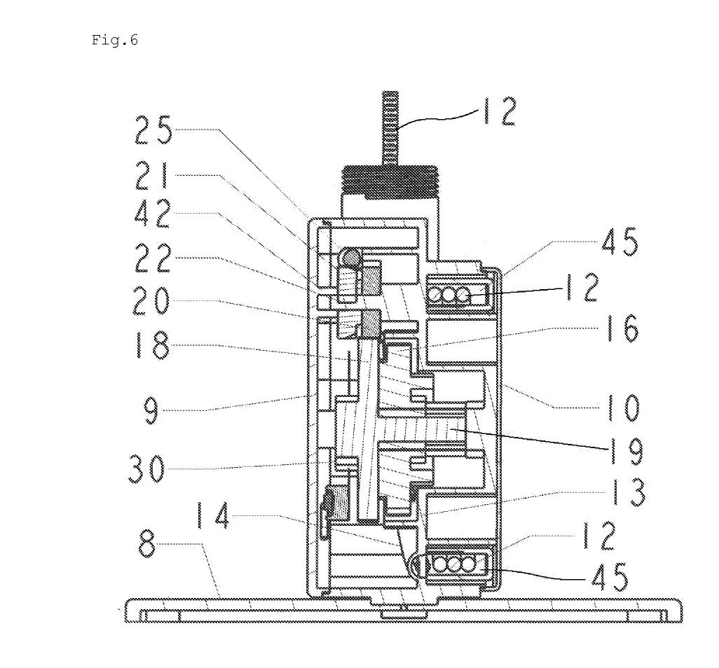

Further, as shown in FIG. 6, each of the front cover 10 and the main body case 9 is provided with a step so that they can be fitted together. A bearing seating 42 of the supporting shaft is installed at a position coaxial with a supporting shaft A22 of a gear installed on the main body case 9. The supporting shaft B19 is constituted in a similar manner. The front cover 10 is screwed to the main body case 9 with screws.

As shown in FIG. 3, an accommodation drum 45 is installed at an accommodating portion at the back of the case barrier 13. The accommodation drum 45 has a U-letter shaped cross section which is opened on the side of a barrier wall at which the drive code 12 is accommodated. The main body case 9 is fitted into the rear cover 11 on an outer circumference and the rear cover 11 is screwed to a screw seating of the case barrier 13 with a screw L43.

The board 8 is assembled to a lower part of the main body 1, thereby supporting the main body 1. Holes at four sites are screw holes for fixing the main body.

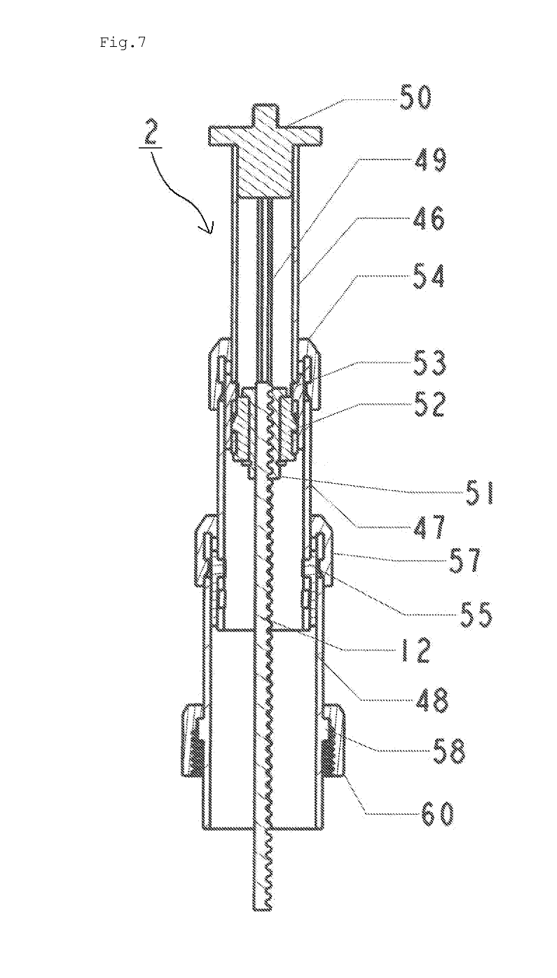

Further, as shown in FIG. 7, the telescoping pole 2 is constituted with a leading-end pole 46, an intermediate pole 47 and a base-end pole 48 and formed so as to be telescoped in a tubular shape. A linear groove 49 is installed on the pole so as to prevent rotational shake, thereby sliding thereon linearly. Amounting head 50 is assembled to an upper part of the leading end pole 46, by which a video camera or the like can be easily mounted on the leading-end pole 46 of the electrically-driven support base. The pole is made of an aluminum alloy which is light in weight and great in strength.

As shown in FIG. 7, a bush for preventing distortion of the drive code 12 is installed at a lower interior of the leading-end pole 46. The bush is made up of an internal bush 51 which is fixed to an upper end of the drive code 12 and an external bush 52 which allows the internal bush 51 to rotate freely and is fixed to a lower part of the leading-end pole 46. The drive code 12 is not necessarily raised linearly when being pushed out, and the drive code 12 may be distorted and raised. In contrast, the pole is raised linearly through the linear groove, by which it is necessary to absorb distortion of the drive code 12. The bush is divided into the internal bush 51 and the external bush 52, thus making it possible to smoothly absorb distortion of the drive code 12 and rotation of the leading-end pole 46.

Further, an S slide bush 53 is assembled to an outer circumference at a lower part of the leading-end pole 46 so as to make a smooth sliding with the intermediate pole 47.

An M guide cap 54 which guides the linear groove 49 of the leading-end pole 46 in a sliding manner is assembled to the leading end of the intermediate pole 47. Next, an M slide bush 55 is also assembled to an outer circumference at a lower part of the intermediate pole 47 so as to make a smooth sliding with the base-end pole 48. An L guide cap 57 which guides the linear groove 49 of the intermediate pole 47 in a sliding manner is assembled to the leading end of the base-end pole 48. A collar 58 necessary for fixing the telescoping pole 2 to the main body 1 with a pole fixing nut 60 is firmly attached to an outer circumference of the base-end pole 48.

The pole assembly portion 3 is installed at an upper end of the main body case 9. An upper face of the pole assembly portion 3 is opened and an upper outer circumference thereof is threaded externally. In order to assemble the telescoping pole 2 thereinto, the base-end pole 48 of the telescoping pole 2 is inserted through an opening portion, then, the collar 58 is aligned with the opening portion, and a pole fixing nut 60 is used to fix the telescoping pole 2 to the pole assembly portion 3. As shown in FIG. 4, the pole lower-channel 15 through which the drive code 12 having one end assembled to the telescoping pole 2 leads to the driver is provided at a lower part of the pole assembly portion 3, and a cord guide 61 is installed at the pole lower-channel 15.

Next, a description will be given of motions of the electrically-driven support base with reference to FIG. 4. Raising, stopping and lowering switches (not illustrated) installed in the front of the lead wire 41 extended from the main body 1 are operated to drive the relay 40. Thereby, electricity is supplied to the electric motor 23, stopped or supplied in a reverse direction to control forward and backward movements of the drive code 12.

In order to raise the telescoping pole 2, the raising switch is operated to supply electricity to the electric motor 23, by which the output shaft 24 of the electric motor 23 rotates in one direction and the rotation is transmitted from the worm gear 25 to the worm wheel 21, the gear A20, the gear B18 and the gear C16. Next, the drive code 12 is pushed out upward to raise the telescoping pole 2. While the telescoping pole 2 is raised, the stop switch is operated to stop supply of electricity. Thereby, the electric motor 23 is stopped and the telescoping pole 2 is also stopped. When the raising switch is again operated and the electric motor 23 rotates again in one direction, the telescoping pole 2 is raised again. When the telescoping pole 2 is raised up to the limit, the fixed contact board A32 shown in FIG. 5 reaches a notch 38 of the movable contact board 35, thereby cutting off the supply of electricity to the fixed contact board A32 and the fixed contact board C34 to stop the electric motor 23 and also stop the telescoping pole 2.

Further, in order to prevent the pole from being lowered due to the weight of a camera and others mounted at the leading-end pole 46 when the telescoping pole 2 is stopped from being raised, a brake is applied to a driving mechanism such as the electric motor 23 or the gear, an electric circuit is installed for retaining loads at the time of stop, a motor is used for retaining loads, a self-locking mechanism is provided by the use of the worm gear 25, or a bush is placed into a clearance between the poles which constitute the telescoping pole 2 to yield a small friction force, thereby preventing the pole from falling down. It is acceptable that the above-described measures are used in combination for preventing the pole from being lowered.

In order to lower the telescoping pole 2 which is raised up to the limit, the lowering switch is operated. Electricity is supplied to the electric motor 23 in a reverse direction and the output shaft 24 of the electric motor 23 rotates in a reverse direction. Next, electricity is transmitted from the worm gear 25 to the worm wheel 21, the gear A20, the gear B18 and the gear C16, by which the drive code 12 is wound up to lower the telescoping pole 2. In order to stop the telescoping pole 2 which is lowered in midstream, the stop switch is operated to stop supply of electricity. When the lowering switch is operated again, the electric motor 23 rotates again in a reverse direction, and the telescoping pole 2 is lowered again. When the telescoping pole is lowered to the limit, a fixed contact board B33 shown in FIG. 5 reaches a notch 38 of the movable contact board 35, cutting off electricity supplied to the fixed contact board B33 and the fixed contact board C34 to stop the electric motor 23 and also stop the telescoping pole 2.

As described so far, an electrically-driven support base of Embodiment 1 is a leg stand which is provided with a main body 1 having an driver that includes an electric motor 23 and gears (16, 18, 20, 25) etc., and also provided with a telescoping pole 2 which is assembled to the main body 1 so that the pole undergoes linear telescopic motion, in which a drive code 12 is assembled to a leading-end pole 46 of the telescoping pole 2. The drive code 12 is pushed out and pulled in by using the driver including the electric motor 23, thereby allowing the telescoping pole 2 to undergo linear telescopic motion. A video camera can be mounted on the leading end of the telescoping pole 2 to elevate electrically a position of the camera.

### Embodiment 2

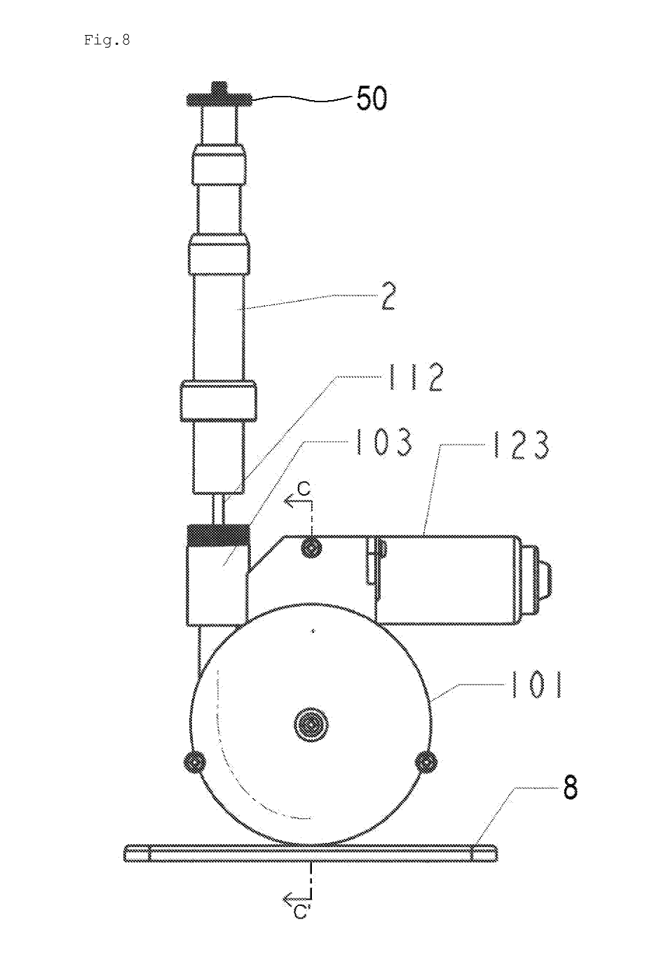

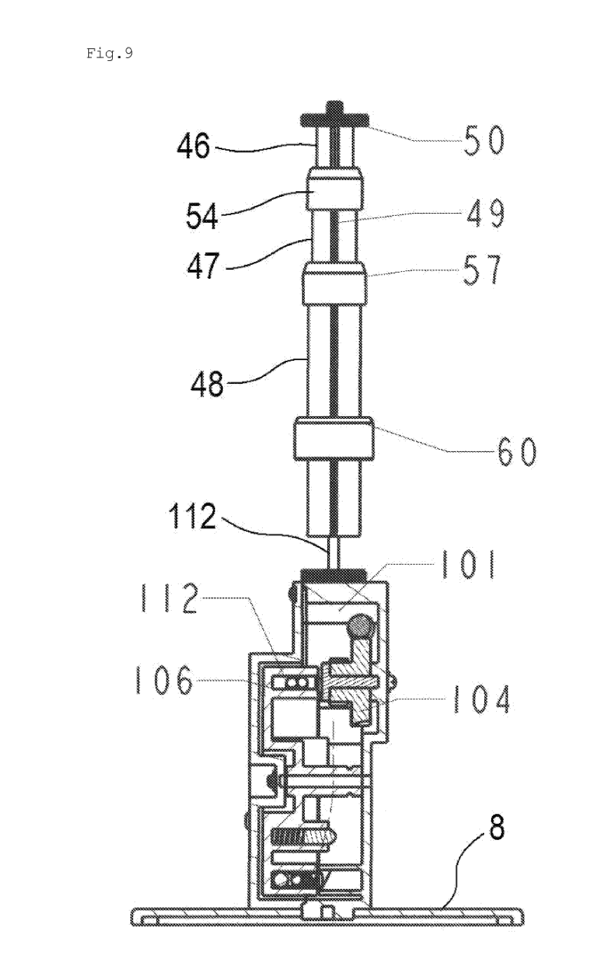

FIG. 8 and FIG. 9 show an electrically-driven support base of Embodiment 2. As with Embodiment 1, the electrically-driven support base of Embodiment 2 is such that a telescoping pole 2 which undergoes linear telescopic motion is assembled to a wind-up main body 101 (FIG. 8, 9). In the electrically-driven support base of Embodiment 2, a wind-up drum 106 of a wind-up driver 104 is rotated normally, stopped and rotated in a reverse direction by using a wind-up electric motor 123, thereby pushing out and pulling in a wind-up drive code 112. Here, the wind-up drive code 112 which allows the telescoping pole 2 to undergo telescopic motion is made of a flexible synthetic resin having an appropriate strength. In addition, in FIG. 8, a controller is omitted. As with Embodiment 1, the electrically-driven support base of Embodiment 2 allows the telescoping pole 2 to undergo linear telescopic motion.

### Embodiment 3

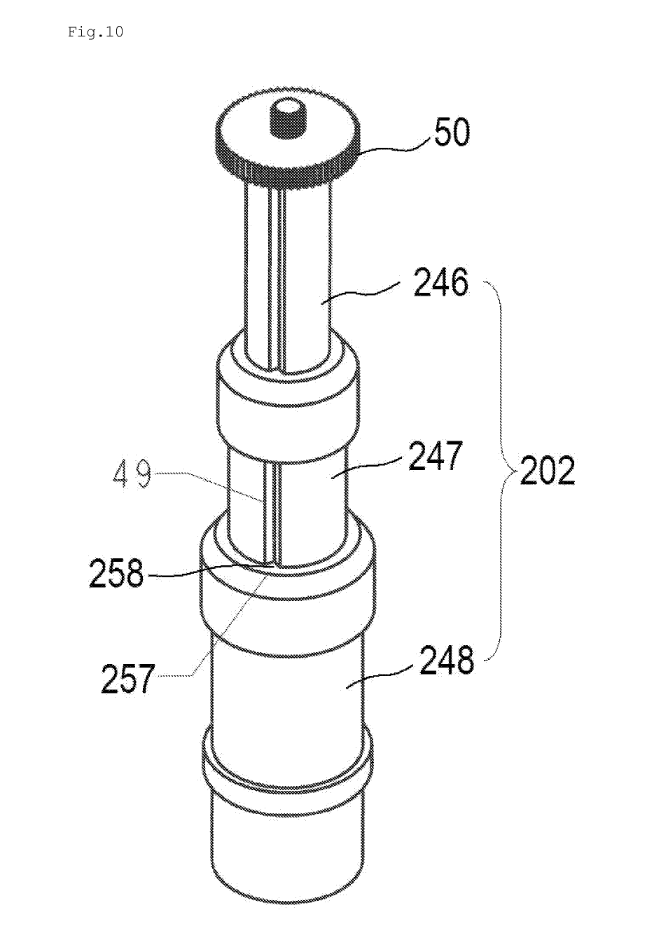

FIG. 10 shows an electrically-driven support base of Embodiment 3. As with Embodiment 1, the electrically-driven support base of Embodiment 3 allows a telescoping pole 202 to undergo linear telescopic motion by using a groove guide 258 of an L guide cap 257, even where it is devoid of a groove on a base-end pole 248 of the telescoping pole 202 (FIG. 10).

### Embodiment 4

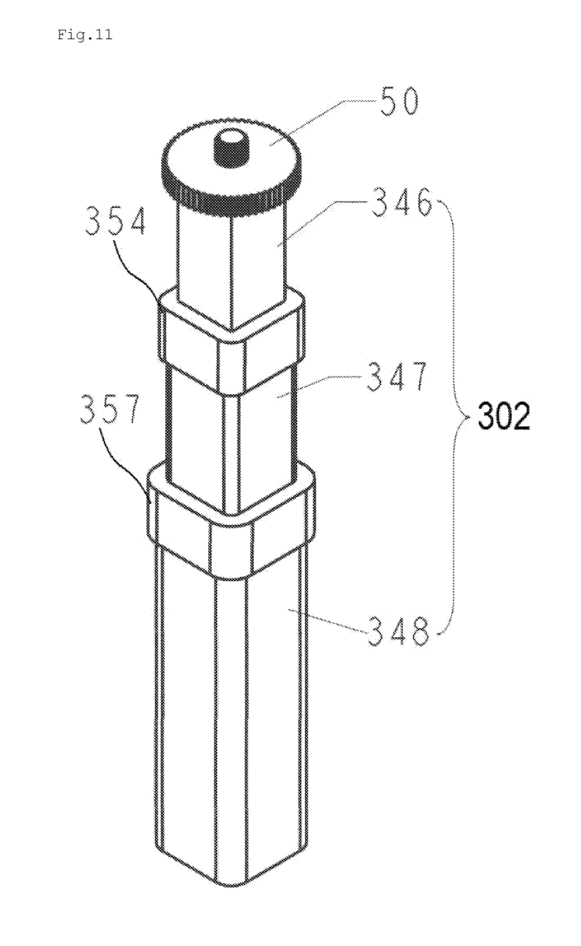

FIG. 11 shows an electrically-driven support base of Embodiment 4. In the electrically-driven support base of Embodiment 4, a rectangular telescoping pole 302 is such that each of a rectangular leading end pole 346, a rectangular intermediate pole 347 and a rectangular base-end pole 348 is formed so as to have a rectangular tubular cross section and so as to be telescoped, and the rectangular telescoping pole 302 is formed so as to slide smoothly and linearly by a rectangular M guide cap 354 and a rectangular L guide cap 357 (FIG. 11). Although not illustrated, a pole assembly portion on the side of a main body is formed so as to be fitted with a rectangular base-end pole 348. As with Embodiment 1, the rectangular telescoping pole 302 is allowed to undergo linear telescopic motion.

### Embodiment 5

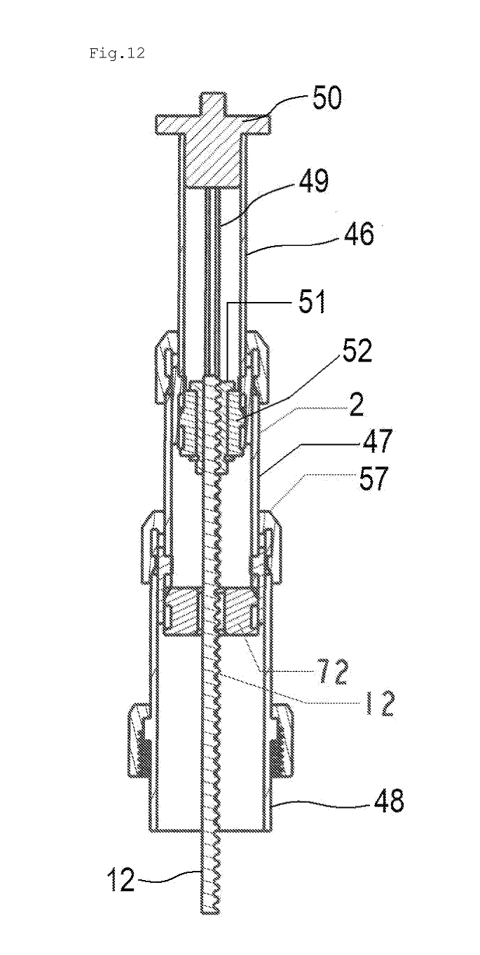

FIG. 12 shows an electrically-driven support base of Embodiment 5. In the electrically-driven support base of Embodiment 5, an intermediate guide 72 is assembled to a lower part of an intermediate pole 47 of a telescoping pole 2 to guide a drive code 12 (FIG. 12). In Embodiment 5, the intermediate guide 72 is installed, by which shake of the drive code 12 inside the intermediate pole 47 can be minimized to reduce buckling, when a camera or the like is mounted on a leading-end pole 46 to receive loads. Further, the drive code 12 is allowed to move smoothly.

### Embodiment 6

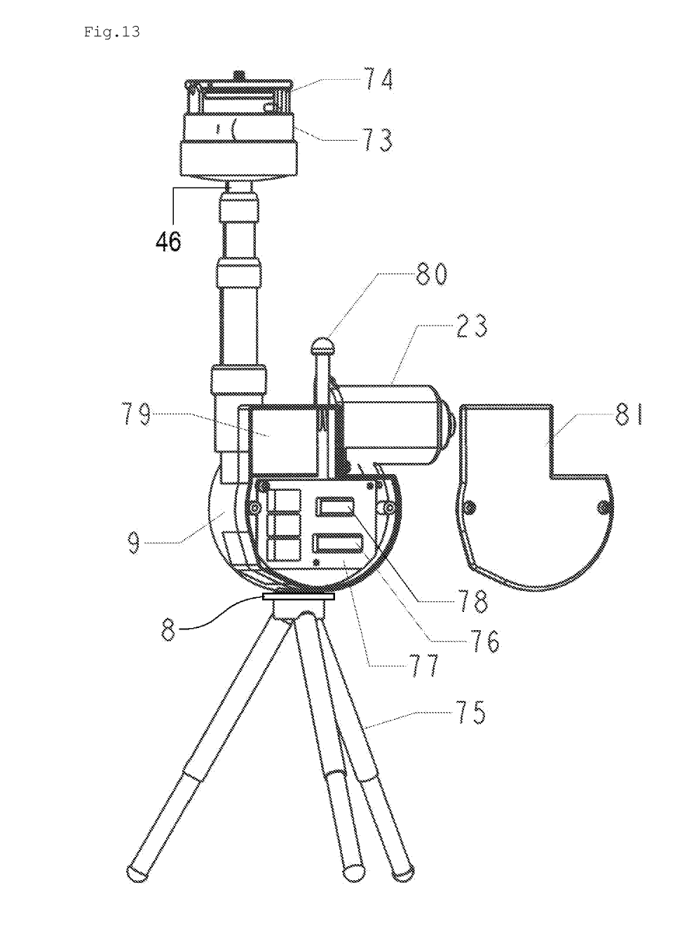

An electrically-driven support base of Embodiment 6 will be explained with referring to FIG. 13. The electrically-driven support base of Embodiment 6 is such that an electrically-driven pan device 73 is assembled to an electrically-driven tilt device 74, which is then assembled to a leading-end pole 46 of a telescoping pole (FIG. 13). In addition, the electrically-driven pan device 73 may be assembled to the electrically-driven tilt device 74 either inside or outside the leading-end pole 46. In Embodiment 6, positional adjustment can be made electrically in a similar manner that a manually-operated tripod in general is used to adjust the position of a pan/tilt elevator.

Further, regarding driving and control of the pan/tilt elevator, a driver is electrically connected up to a controller, and electricity of a battery installed at a main body is supplied to actuate the driver. Still further, the controller can be controlled by wireless communications.

### Embodiment 7

An electrically-driven support base of Embodiment 7 will be explained with referring to FIG. 13. In Embodiment 7, a tripod 75 is assembled on the bottom of a board 8 below a main body, which allows pictures to be taken at an installation location other than a flat place or at a higher position.

### Embodiment 8

An electrically-driven support base of Embodiment 8 will be explained with referring to FIG. 13. The electrically-driven support base of Embodiment 8 is such that a signal sending/receiving controller 76 which allows a telescoping pole 2 to undergo linear telescopic motion by wireless or infrared communications is assembled to a main body 1. A sending/receiving case 79 is assembled to a main body case 9, a signal sending/receiving portion 80 is installed at an upper part of the sending/receiving case 79, and a printed wiring board 77 and a battery 76 are arranged in the sending/receiving case 79. Next, a rear cover 81 is fitted into the sending/receiving case 79 and assembled thereto with a screw. The electrically-driven support base of Embodiment 8 is able to remote-control the telescoping pole so as to undergo telescopic motion.

### Embodiment 9

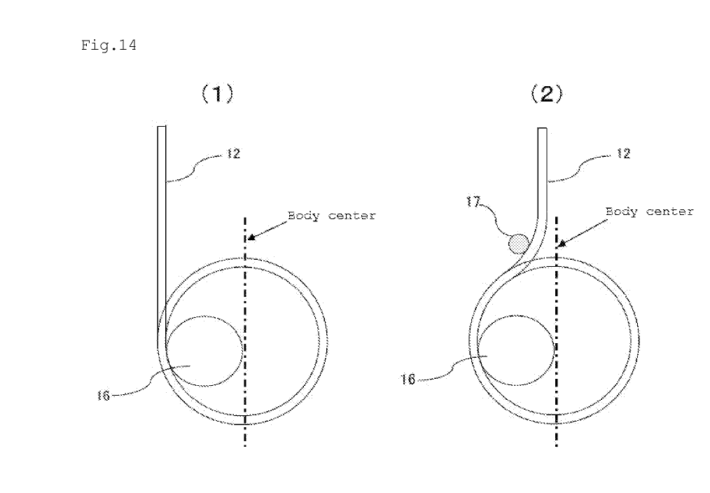

An electrically-driven support base of Embodiment 9 will be explained with referring to FIG. 14. The electrically-driven support base of Embodiment 9 is such that the gravity point of a multi-stage telescoping pole is arranged so as to be located at the center of a main body (body center) as much as possible. As shown in FIG. 14(1), the center of a drive code 12 which is pushed out will deviate from the body center. Therefore, when a camera is mounted on the leading end of the drive code 12, that is, the leading end of a pole, the gravity point undergoes positional deviation, which may make an unstable electrically-driven support base. Thus, as shown in FIG. 14(2), in the electrically-driven support base of Embodiment 9, a guide 17 is arranged so as to make the center of the drive code 12 close to the body center. Thereby, the center of the drive code 12 is allowed to come close to the body center, thereby making stable the electrically-driven support base.

### Other Embodiments

(1) In said embodiments, a structure for allowing the telescoping pole to undergo linear telescopic motion is provided so as to have a recessed groove at two sites. It is, however, acceptable that the groove is a raised groove. It is also acceptable that at least one groove is sufficient and two or more grooves are provided.

(2) In said embodiments, the telescoping pole is constituted with a leading-end pole, an intermediate pole and a base-end pole. The telescoping pole can be constituted with only the leading end pole and the base-end pole. It is also possible to provide a plurality of intermediate poles.

(3) Poles which allow the telescoping pole to undergo linear telescopic motion can be combined in any cross-sectional shape, that is, oval, star shape, semi-circle, or circle, polygon, oval and semi-circle. Further, the cap is changed in shape, thus making it possible to combine poles, each cross section of which is different in shape.

(4) The drive code can be formed so as to give a cross section which is a rectangular or oval shape etc., other than the circle of said embodiments. Further, the drive code may be made of a composite in combination of a resin with a fiber or a metal wire so as to be flexible and strong.

(5) In said embodiments, the pan device and the tilt device are assembled to the leading end of the telescoping pole. It is acceptable that only the pan device is assembled to a lower part of the main body.

(6) It is acceptable that the electrically driven leg stand of said embodiments is suspended from a ceiling or the like, with the leg stand being upside down.

### INDUSTRIAL APPLICABILITY

The present invention is usefully applicable for an electrically-driven support base of a camera.

### DESCRIPTION OF SYMBOLS

1 Main body
2 Telescoping pole
3 Pole assembly portion
8 Board
9 Main body case
12 Drive code
23 Electric motor
45 Accommodation drum
49 Linear groove
50 Mounting head
72 Intermediate guide
76 Signal sending/receiving controller

1. An electrically-driven support base which is a device in which one end of a flexible transmission belt is coupled to a multi-stage telescoping pole having a mounting head at a leading-end pole, the transmission belt is engaged with a gear coupled to an electric motor, by which the transmission belt is pushed out or pulled in, thereby allowing the multi-stage telescoping pole to undergo telescopic motion, wherein
a camera unit can be mounted on the mounting head,
a rotational-shake prevention unit is installed on a pole at each stage in the multi-stage telescoping pole, and
an intermediate guide which guides the transmission belt to reduce buckling of the transmission belt is installed inside an intermediate pole of the multi-stage telescoping pole.

2. The electrically-driven support base according to claim 1, wherein
the rotational-shake prevention unit is such that a linear groove is installed axially on a wall of a pole at each stage so that the multi-stage telescoping pole undergoes linear telescopic motion.

3. The electrically-driven support base according to claim 1, wherein
said pole at each stage has a cross section, the shape of which is a combination of tubular polygon, tubular oval and tubular semi-circle as well as circle, polygon, oval and semi-circle, and the pole at each stage is telescoped, thereby allowing the multi-stage telescoping pole to undergo linear telescopic motion.

4. The electrically-driven support base according to claim 1,
wherein the intermediate guide of the transmission belt is installed on the intermediate pole of the multi-stage telescoping pole.

5. The electrically-driven support base according to claim 1, wherein the mounting head is additionally provided with a driving unit which pans or tilts a camera unit or a camera lens internally housed in the camera unit, and the driving unit can be operated by wire or wireless communications.

6. The electrically-driven support base according to claim 1, wherein a tripod is mounted on a main body of the electrically-driven support base.

7. The electrically-driven support base according to claim 1, wherein a signal sending/receiving device which is capable of remote-controlling elevation of the multi-stage telescoping pole by wireless or infrared communications is assembled into the main body thereof.
